(19) United States
(12) Patent Application Publication
(10) Pub. No.: US 2022/0197360 A1
(43) Pub. Date: Jun. 23, 2022

(54) Computing Devices

(71) Applicant: Hewlett-Packard Development Company, L.P., Spring, TX (US)

(72) Inventors: Shaheen Saroor, Spring, TX (US); Robert C. Brooks, Spring, TX (US); Jeffrey C. Stevens, Spring, TX (US)

(73) Assignee: Hewlett-Packard Development Company, L.P., Spring, TX (US)

(21) Appl. No.: 17/606,089

(22) PCT Filed: Jul. 31, 2019
(86) PCT No.: PCT/US2019/044531

§ 371 Date: Oct. 25, 2021

(51) Int. Cl. G06F 1/26; G06F 1/20; G06F 1/3206

(52) U.S. Cl. CPC G06F 1/266; G06F 1/3206; G06F 1/206; G06F 1/263

(57) ABSTRACT

A computing device is disclosed. The computing device includes a processing device having a rating of a first power amount. The computing device includes a processing infrastructure coupled to the processing device. The processing infrastructure is configured for a second power amount in which the second power amount is greater than the first power amount. The processing device is configurable to operate at the first power amount and the second power amount.

### BACKGROUND

Computing devices are machines that can be instructed to carry out arithmetic or logical operations automatically via computer programming and can follow generalized sets of operations, called programs. The programs enable computing devices to perform an extremely wide range of tasks. A computer system can include hardware, an operating system, and peripheral equipment used for operation Computing devices can take a wide variety of forms and are used as control systems for a wide variety of industrial and consumer applications. This includes simple special purpose computing devices such as printing devices; industrial robots; general-purpose devices including workstations, servers, personal computers, laptops, and mobile devices such as tablets and smartphones; and consumer devices such as video game consoles. Computing devices can be stand-alone devices or configured as part of a computer network.

### BRIEF DESCRIPTION OF THE DRAWINGS

FIG. 1 is a block diagram illustrating an example computing device.

FIG. 2 is a block diagram illustrating another example computing device according to the computing device of FIG. 1.

FIG. 3 is a block diagram illustrating an example method to construct the computing device of FIG. 1.

### DETAILED DESCRIPTION

Computing device producers, such as a computing device manufacturer and seller, may include a computing device portfolio of multiple desktops, laptops, and mobile devices and may include several brand platforms. For example, some form factors in a brand of commercial desktop personal computer have multiple platforms that are designed and built to feature a particular processing device, such as a central processing unit, level of performance, feature set, or price point. In some examples, each platform can include an individual stock keeping unit, or SKU, which identifies a distinct item for sale and attributes associated with the item distinguish it from other items in the portfolio. Each platform, however, generates costs in terms of engineering effort, validation and testing, inventory storage, forecasts, and management efforts that increase the cost of production of the computing device.

The disclosure is directed to a single computing device platform that can achieve a high level of performance or power of a portfolio of computing device platforms, but can be selectively configured to one of a number of platforms of the portfolio. In one example, the computing device platform can include a processor rated for an intermediate amount of power and a processing infrastructure, such as a power system and a cooling system, that is configured for a processor rated for a high amount of power. The computing device can be configured to one of a number of the platforms of the portfolio by setting the processor to a power amount, such as the intermediate power amount, the high power amount, or another power amount such as a low power amount. For example, if the single computing device platform was designed to include a 65 watt processor with a power supply and cooling system designed for a 90 watt processor, the computing device platform could be selectively configured to operate the processor at 35 watts, 65 watts, or 90 watts such as via power level settings of the processor. While the cost of the components of the single platform may exceed those of lower level platform designs in the computing device portfolio, the reduction of the number of platforms in the portfolio reduces other costs of maintaining the portfolio such as design and validation of multiple circuit assemblies and other costs.

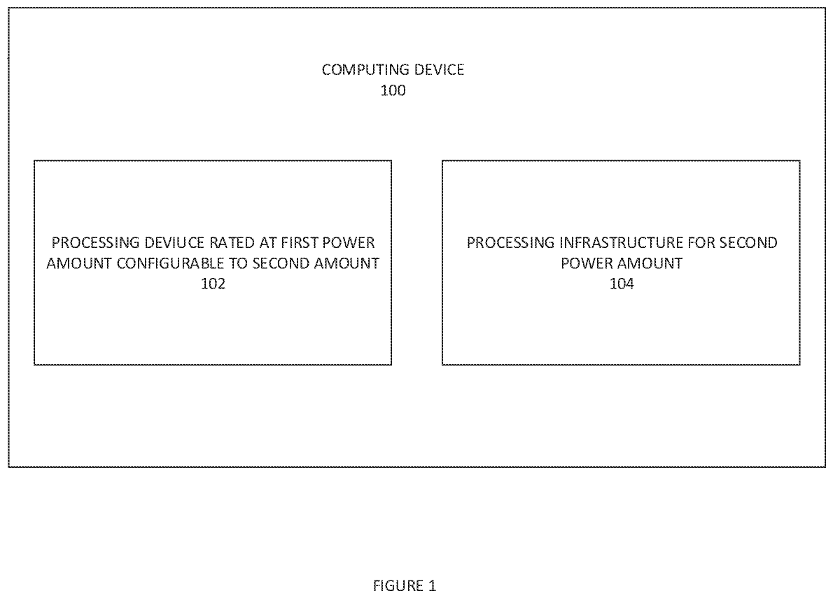

FIG. 1 illustrates an example computing device 100 that can achieve a high level, such as the highest level, of performance or power platform in a particular computing device portfolio but can be configured and provided as another platform in the portfolio. In the example, the computing device 100 includes a processing device 102 having a rating of a first power amount, such as an intermediate power amount. For instance, the first power amount can be in terms of watts and can include an intermediate power rating in a family of processing devices having a rating of a high power amount and the rating of the intermediate power amount. The computing device 100 also includes a processing infrastructure 104 coupled to the processing device 102. The processing infrastructure 104 can include a power system, a cooling system, or both, that are configured to operate with the processing device 102. The processing infrastructure 104 is configured for a second power amount in which the second power amount is greater than the first power amount. For instance, rather than a processing infrastructure configured for a processor having a rating of an intermediate power amount, the processing infrastructure is configured for a processor having a rating of a high power amount. The processing device 102 is selectably configurable to operate at the first power amount and the second power amount. In another example, the processing devices is also selectably configurable to operate at a low power amount, which is less than the intermediate power amount.

In one example, the computing device 100 can include a processing device 102 rated at 65 watts and include the processing infrastructure 104 configured for a processing device rated at 90 watts. The processing device can be selectively configured to draw 65 watts or draw 90 watts. In an additional example, the processing device 102 can be selectively configured to draw 35 watts. In these examples, a single computing device platform can be configured and sold as any one of a plurality of platforms in the computing device portfolio.

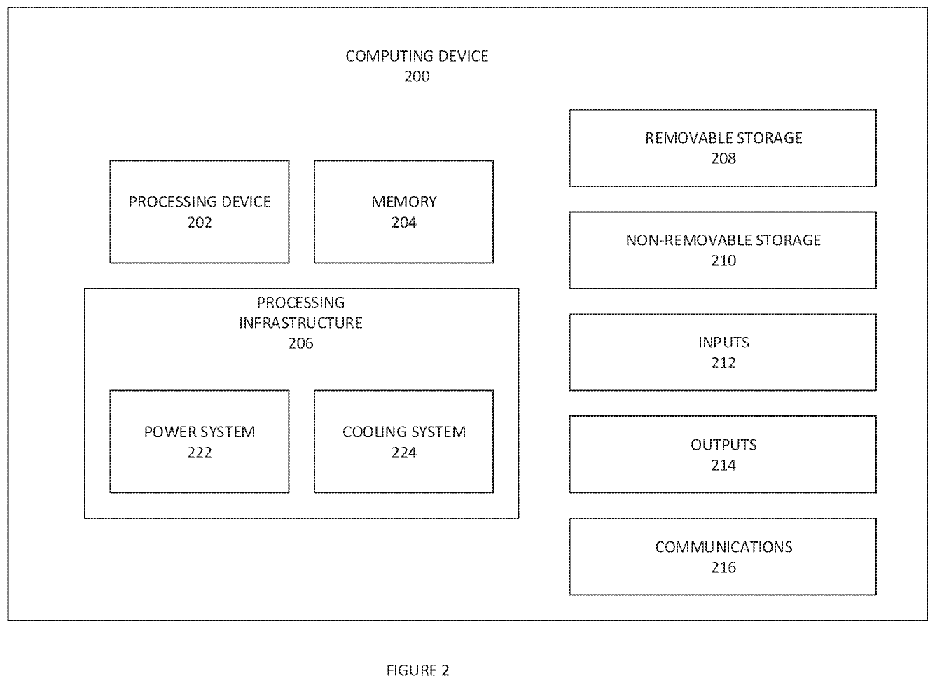

FIG. 2 illustrates an example computing device 200, which can be constructed in accordance with computing device 100 and provide a plurality of platforms in a computing device portfolio. The computing device 200 can take several forms such as a tablet, a personal computer, a laptop, a workstation, a server, a handheld device, or a consumer electronic device, and can be a stand-alone device or configured as part of a computer network.

In a hardware configuration, computing device 200 typically includes a processor system having a processing unit, i.e., a processing device 202 and memory 204. By way of example, the processing device 202 may include a plurality of processing cores on a chip or a plurality of processor chips. For example, the processing device 202 can include a central processing unit, or CPU. In some examples, the processing device 202 can also include an additional processor or specialized processors, such as a graphics processor for general-purpose computing on an integrated processing circuit or graphics processor units, to perform processing functions offloaded from the CPU. The memory 204 may be arranged in a hierarchy and may include one or more levels of cache. Depending on the configuration and type of computing device, memory 104 may be volatile (such as random access memory (RAM)), non-volatile (such as read only memory (ROM), flash memory, etc.), or a combination of the two. In some example, memory 204 may be integrated into the processing device 202.

The computing device 200 also includes a processing infrastructure 206 operably coupled to the processing device 202. In one example, the processing device 202 can include certain parameters for operation, such as a power input, as well as certain features to maintain operation, such as cooling. Processing infrastructure 206 can provide support for the operation of the processing device 202. In one example, the processing infrastructure 206 can include a power system 222 operably coupled to the processing device 202 to provide electrical power in the form of voltage and current to the processing device. For example, the power system 222 can include a power supply unit, such as a switched mode power supply, to convert a mains alternating current (AC) to an appropriate voltage direct current (DC) power for the computing device 200 or provide an AC to DC conversion and a DC to DC conversion for a rechargeable battery-powered computing device 200 coupled to components of the computer system 200 including the processor. In some examples, the power system can include a voltage regulator module, or processor power module, that can provide multiple supply voltages to components on a motherboard or the computing device. The processor infrastructure 206 can include a cooling system 224, such as a heat sink and cooling fan, operably coupled to the processing device 202, to remove waste heat from the processing device and maintain an operating temperature within specifications. In some examples, the cooling system 224 may include additional features such as openings in the case to permit airflow or liquid cooling structures such as conduits, fluids, and heat exchangers to facilitate liquid cooling of the processing device 202 and computing device components.

Computing device 200 can also have additional features or functionality. For example, computing device 100 may also include additional storage. Such storage may be removable or non-removable and can include magnetic or optical disks, solid-state memory, or flash storage devices such as removable storage 208 and non-removable storage 210. Computer storage media includes volatile and nonvolatile, removable and non-removable media implemented in a suitable method or technology for storage of information such as computer readable instructions, data structures, program modules or other data. Memory 204, removable storage 208 and non-removable storage 210 are examples of computer storage media. Computer storage media includes RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or other storage medium that can be used to store the desired information and that can be accessed by computing device 200. Accordingly, a propagating signal by itself does not qualify as storage media. Any such computer storage media may be part of computing device 200.

Computing device 200 often includes input connections, output connections, or input/output connections such as USB connections, display ports, and proprietary connections to connect to various devices to provide inputs and outputs to the computing device. Input devices may include devices such as keyboard, pointing device (such as a mouse, track pad), stylus, voice input device, and touch input device (such as a touchscreen). Output devices may include devices such as a display, speakers, and printing devices. An example computing device may include input devices 212 such as a keyboard, track pad, and microphone and output devices 214 such as a display and speakers.

Computing device 200 often includes one or more communication connections 216 that allow computing device 200 to communicate with other computers or applications. Example communication connections can include an Ethernet interface, a wireless interface, a bus interface, a storage area network interface, and a proprietary interface. The communication connections can be used to couple the computing device 200 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, and the internet.

In the example, the processing device 200 includes a rating of a first power amount, and the first power amount can be defined in terms of watts. The processing device 202 may be selected from a set or family processing devices of a processing device manufacturer that may include a plurality of ratings such as a processing device having a rating of a low power amount, a processing device having a rating of an intermediate power amount, and a processing device having a rating of a high power amount. In some examples, the family of processing devices may include processor devices of an even higher power amount or other power amount. For example, a type of processing device family may include processing devices rated at 65 watts or 90 watts, or the family may include processing devices rated at 35 watts, 65 watts, and 90 watts. Typically, a computer designer and manufacturer may construct an example portfolio including a first and second computing devices in which the first computing device includes a processing device selected from the family of processing devices having a rating of an intermediate power amount and which includes a processing infrastructure of particular components configured for the processing device having the rating of the intermediate power amount, and may construct the separate, second computing device having a processing device selected from the family of processing devices having a rating of a high power amount and which includes a processing infrastructure of particular components configured for the processing device having the rating of the high power amount. Thus, the first and second computing device in the example portfolio each include separate processors and separate processing infrastructures. In computing device 200, the processing device 202 can be selected to have a rating of a first power amount, such as an intermediate or low power amount, such as 65 watts, and include a processing infrastructure 204, such as a power system 222 and cooling system 224, that is configured for a second power amount, such as 90 watts, in a computing device portfolio. The processing device 202 is selectably configurable for the first power amount, such as 65 watts, and the second power amount, such as 90 watts. The computing device 200 can be selectively configured, such as prior to shipping or delivery, as having a 65 watt rating or a 90 watt rating by adjusting settings in the processing device 202.

Processing device 202 may include processor technology to control performance of the processing cores, including CPU cores and graphics processing cores in, for example, integrated graphics processors, that may affect system parameters such as thermal output, power, and current levels. The processor technology may operate the processor at the highest level of rated performance within the acceptable operating parameters. For instance, the processor technology may reduce performance of the processing device 202 if an operating parameter falls outside an acceptable limit. Various parameter levels or performance amounts can be affected by processor control registers, such as a model-specific register (MSR), which can control or monitor features of the processing device 202.

In one example, a parameter can include thermal design power, or TDP, which is the power level or power amount at which the processing device 202 is configured to operate in a sustained mode with an corresponding processing infrastructure 204. The processing device includes a power level parameter PL1, which is the TDP level setting of the processor package power. When an exponentially weighted moving average, or EWMA, of the processing power reaches PL1, the processor technology generally lowers processor performance, such as clock frequency, to maintain the PL1 level. If the EWMA of the processing power drops below PL1, the processing technology may raise clock frequency. The PL1 value is set in a processor control register to affect processing device features, such as a model-specific register (MSR), as MSR 0x610 [PKG_PWR_LIM_1] and is enabled by setting MSR 0x610 by setting PKG_PWR_LIM_1_EN. A temporary processor package power level, or PL2, which is greater than PL1, can be sustained while the EWMA is below PL1 to cause the processor power to converge on PL1. The PL2 value is set in MSR 0x610[PKG_PWR_LIM_2] and is enabled by setting MSR 0x610[PKG_PWR_LIM_2_EN]. Another value, TAU is an averaging constant that determines how quickly the EWMA will respond to changes. For example, the EWMA responds more quickly as TAU decreases. The TAU value is set in MSR 0x610[PKG_PWR_LIM_1_TIME]. Parameter PL4 represents the processing device power limit. In one example of a processing device, a PL4 power level can be sustained for less than 10 milliseconds. The PL4 value is set in MSR 0x601[CURRENT_LIMIT], which is done with consideration of the processing infrastructure 204.

In addition to processing power levels, the processing device 202 also responds to system or platform power level settings, which can be abbreviated as SYS_PL. For example, a parameter PSYS_PL1 is a sustained system power level in which a voltage regulator monitors system power at a PSYS pin and can provide a signal representing system power levels to the processing device over a bus such as a Serial Voltage Identification Debug (SVID) bus coupling the voltage regulator to the processing device 202. When enabled, the processing device 202 will adjust frequencies such that system power remains at or below the power level set in the PSYS_PL1 register. The PSYS_PL1 value is set in MSR 0x65C[PsysPL1] and is enabled by 0x65C[PsysPL1_Enable]. The parameter PSYS_PL2 represents the system peak power limit and is typically set significantly higher than PSYS_PL1. The processing device 202 will adjust its frequencies to maintain a system power at or below the power level set in the PSYS_PL2 register. The PSYS_PL2 value is set in MSR 0x65C[PsysPL2] and is enabled by 0x65C[PsysPL2_Enable]. The parameter PSYS_PMAX is the system maximum power level that is identifiable by the voltage regulator and processing device 202 when the voltage on the voltage regulator PSYS input equals the reference voltage.

The processing infrastructure 206 can be configured to provide support for a processing device 202 of a second power amount, such as the high power amount for a processing device family. In one example, the power system 222 can include a power supply unit used for a processing device of the second power amount. The voltage regulator can also be configured for a processing device of the second power amount. The SVID bus can be monitored to determine whether the voltage regulator is providing an appropriate current to the processing device of the second power amount. The cooling system 224 can be configured to support a processing device of the second power amount. For example, a heat sink can be constructed to include a higher heat conductivity for a processing device of the second power amount. Additionally, the fan can be configured for a processing device of the second power amount, such as increased fan speed within acceptable acoustic levels.

The processing device 202 is selectably configurable for the first power amount and the second power amount. For example, the processing device 202 is configured, such as via adjusting the PL settings, such as PL1, PL2 and PL4 settings, to operate at the second power amount. Additionally, the processing device 202 can be configured, also via adjusting the PL settings, to operate at a third power amount, which is less than the first power amount.

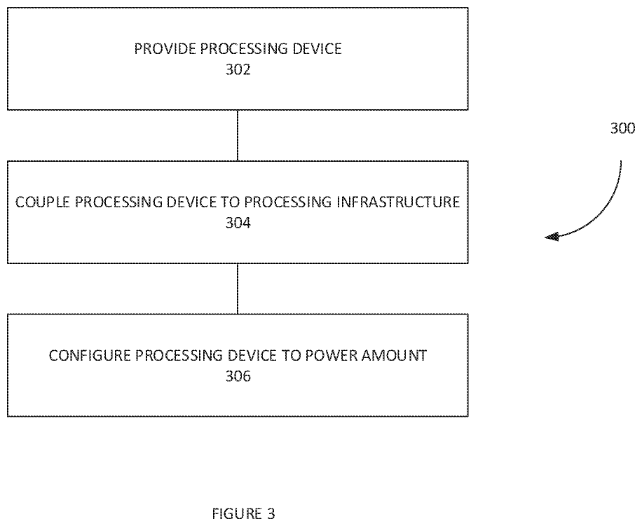

FIG. 3 illustrates a method 300 of manufacturing computing device 100, such as computing device 200. The computing device 100 is provided with a processing device 202 having a rating of a first power amount at 302. In one example, the first power amount is an intermediate power amount in a family of processing devices having a rating of an intermediate power amount a high power amount greater than the intermediate power amount, and a low power amount less than the intermediate power amount. A processing infrastructure 204 is coupled to the processing device 202, the processing infrastructure 204 configured for the second power amount, the second power amount being greater than the first power amount. In one example, the processing infrastructure is configured to support a processing device having a rating of the high power amount, or the highest power amount in the family of processing devices.

The processing device 202 is configured for one of the second power amount and a third power amount in which the third power amount is less than the first power amount at 306. In one example, the processing device 202 is selectably configured for the second or third power amounts via adjusting the settings of PL1, PL2, and PL4. In the example in which the processing device is selectably configured for the second power amount, the processing device 202 is coupled to the processing infrastructure 204 prior to selectably configuring the processing device 202. Other power management features could be disabled. The settings of PL1, PL2, and PL4 may be adjusted, and a utility application, such as one available under the trade designation Thermal Analysis Tool from Intel Corp. of Santa Clara, Calif., can be used to determine whether the processor technology has limited processor performance against a benchmark application such as one available under the trade designation Cinebench from Maxon Computer GmbH of Friedrichsdorf, Germany. If the processor technology has limited processor performance against the benchmark application, the reasons for the limitations can be addressed by modifying values of the registers. Causes may include high current spikes, PL levels not set high enough, and not enough cooling support, which can be determined form the reasons for the limitations according to the utility application.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A computing device, comprising:
a processing device having a rating of a first power amount;
a processing infrastructure operably coupled to the processing device, the processing infrastructure configured for a second power amount, the second power amount being greater than the first power amount; and
the processing device selectably configurable for the first power amount and the second power amount.

2. The computing device of claim 1 wherein the processing device includes a central processing unit.

3. The computing device of claim 1 wherein the rating is in watts.

4. The computing device of claim 3 wherein the first power amount is 65 watts.

5. The computing device of claim 4 wherein the second power amount is 90 watts.

6. The computing device of claim 1 wherein the processing infrastructure includes a power supply, a voltage regulator, and a cooling system.

7. The computing device of claim 1 wherein the processing device is further selectively configurable for a third power amount wherein the third power amount is less than the first power amount.

8. The computing device of claim 7 wherein the third power amount is 35 watts.

9. The computing device of claim 1 wherein the processing device is further selectively configurable for a higher power amount wherein the higher power amount is greater than the second power amount.

10. A computing device, comprising:
a processing device having a rating of an intermediate power amount;
a power system operably coupled to the processing device, the power system configured for a high power amount, the high power amount being greater than the intermediate power amount; and
the processing device selectably configurable for the intermediate power amount, the high power amount, and a low power amount wherein the low power amount is less than intermediate power amount.

11. The computing device of claim 10 wherein the high power amount is 90 watts, the intermediate power amount is 65 watts, and the low power amount is 35 watts.

12. The computing device of claim 10 wherein the power system includes a power supply and voltage regulator.

13. The computing device of claim 10 comprising a cooling system having a heat sink and fan, the cooling system configured for the high power amount.

14. A method of manufacturing a computing device, the method comprising:
providing a processing device having a rating of a first power amount;
coupling a processing infrastructure to the processing device, the processing infrastructure configured for a second power amount, the second power amount being greater than the first power amount; and
configuring the processing device for one the second power amount and a third power amount wherein the third power amount is less than the first power amount.

15. The method of claim 14 wherein the coupling a processing infrastructure to the processing device includes coupling a power system and a cooling system to the processing device.
